(19) United States
(12) Patent Application Publication
(10) Pub. No.: US 2023/0390921 A1
(43) Pub. Date: Dec. 7, 2023

(54) SIMULATION MODEL CORRECTION OF A MACHINE SYSTEM

(71) Applicant: KABUSHIKI KAISHA YASKAWA DENKI, Kitakyushu-shi (JP)

(72) Inventors: Sae SAKATA, Fukuoka (JP); Yukihiro TOBATA, Fukuoka (JP)

(21) Appl. No.: 18/450,406

(22) Filed: Aug. 16, 2023

Related U.S. Application Data
(63) Continuation of application No. PCT/JP2021/007415, filed on Feb. 26, 2021.

(51) Int. Cl. B25J 9/16; G06T 17/00; G06T 7/70

(52) U.S. Cl. CPC B25J 9/1671; B25J 9/1697; G06T 17/00; G06T 7/70; G06T 2207/10028

(57) ABSTRACT

The simulation device include circuitry configured to: store a simulation model of a machine system including a robot, the simulation model generated to simulate a three-dimensional real shape of the machine system; receive measured data acquired by measuring the machine system in a real space; generate, based on the measured data, an actual shape model representing a three-dimensional real shape of the machine system; and correct the simulation model of the machine system based on a comparison between the simulation model and the actual shape model.

### CROSS-REFERENCE TO RELATED APPLICATIONS

This application is a continuation application of PCT Application No. PCT/JP2021/007415, filed on Feb. 26, 2021, the entire contents of which are incorporated herein by reference.

### BACKGROUND

### Field

The present disclosure relates to a simulation device, a control system, a modeling method and a memory device.

### Description of the Related Art

Japanese Unexamined Patent Publication No. 2018-134703 discloses a robot simulator including: a model storage unit that stores model information related to a robot and an obstacle; and an information processing unit that generates a path that allows a tip part of the robot to move from a start position to an end position based on the model information while avoiding a collision between the robot and the obstacle.

### SUMMARY

Disclosed herein is a simulation device. The simulation device may include circuitry configured to: store a simulation model of a machine system including a robot, the simulation model generated to simulate a three-dimensional real shape of the machine system; receive measured data acquired by measuring the machine system in a real space; generate, based on the measured data, an actual shape model representing a three-dimensional real shape of the machine system; and correct the simulation model of the machine system based on a comparison between the simulation model and the actual shape model.

Additionally, a modeling method is disclosed herein. The method may include: storing a simulation model of a machine system including a robot, the simulation model generated to simulate a three-dimensional real shape of the machine system; receiving measured data acquired by measuring the machine system in a real space; generating, based on the measured data, an actual shape model representing a three-dimensional real shape of the machine system; and correcting the simulation model of the machine system based on a comparison between the simulation model and the actual shape model.

Additionally, a non-transitory memory device is disclosed herein. The memory device may have instructions stored thereon that, in response to execution by a processing device, cause the processing device to perform operations including: storing a simulation model of a machine system including a robot, the simulation model generated to simulate a three-dimensional real shape of the machine system; receiving measured data acquired by measuring the machine system in a real space; generating, based on the measured data, an actual shape model representing a three-dimensional real shape of the machine system; and correcting the simulation model of the machine system based on a comparison between the simulation model and the actual shape model.

### BRIEF DESCRIPTION OF THE DRAWINGS

FIG. 1 is a schematic diagram illustrating an example configuration of an automation system.

FIG. 2 is a schematic diagram illustrating an example configuration of a robot.

FIG. 3 is a block diagram illustrating an example functional configuration of a simulation device.

FIG. 4 is a diagram illustrating an example object to be captured by a three-dimensional camera.

FIG. 5 is a diagram illustrating an example three-dimensional image of an object in FIG. 4.

FIG. 6 is a diagram illustrating an example actual shape model acquired by synthesizing the three-dimensional image.

FIG. 7 is a diagram illustrating an example actual shape model.

FIG. 8 is a diagram illustrating an example simulation model.

FIG. 9 is a diagram illustrating an example matching operation.

FIG. 10 is a diagram illustrating an example matching operation.

FIG. 11 is a diagram illustrating an example matching operation.

FIG. 12 is a diagram illustrating an example matching operation.

FIG. 13 is a diagram illustrating an example matching operation.

FIG. 14 is a diagram illustrating an example matching operation.

FIG. 15 is a diagram illustrating an example matching operation.

FIG. 16 is a diagram illustrating an example corrected simulation model.

FIG. 17 is a diagram illustrating an example object to be photographed by the three-dimensional camera.

FIG. 18 is a diagram illustrating an example actual shape model of the object to be photographed in FIG. 17.

FIG. 19 is a diagram illustrating an example pre-processed model of the object to be photographed in FIG. 17.

FIG. 20 is a block diagram illustrating an example hardware configuration of the simulation device.

FIG. 21 is a flow chart illustrating an example modeling procedure.

FIG. 22 is a flow chart illustrating an example modeling procedure.

### DETAILED DESCRIPTION

In the following description, with reference to the drawings, the same reference numbers are assigned to the same components or to similar components having the same function, and overlapping description is omitted.

Automation System

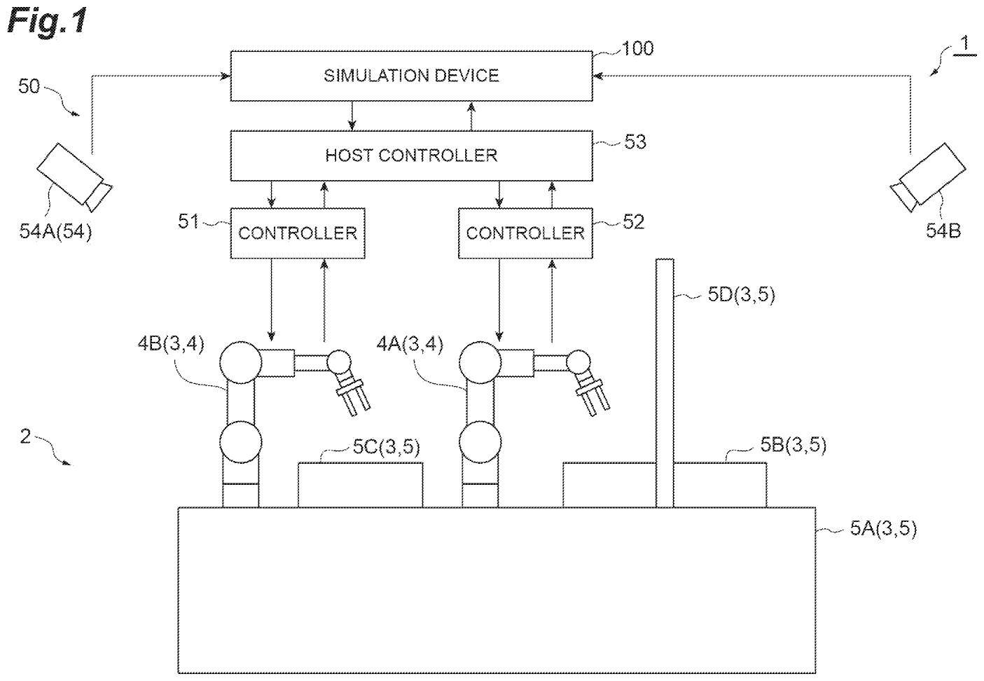

An automation system 1 illustrated in FIG. 1 is a system for operating at least a robot in a machine system including at least the robot. Examples of the automation system 1 include a production system that operates at least a robot so as to produce a product in a machine system, but the application of the machine system may not be limited to the production of a product.

The automation system 1 includes a machine system 2 and a control system 50. The machine system 2 includes a plurality of objects 3. Each of the object 3 is a substantial object occupying a part of a three-dimensional real space. The objects 3 includes at least one control target object 4 to be controlled and at least one peripheral object 5.

The at least one control target object 4 includes at least one robot. In FIG. 1, two robots 4A, 4B are illustrated as the at least one control target object 4, and a main stage 5A, sub stages 5B, 5C, and a frame 5D are illustrated as the at least one peripheral object 5.

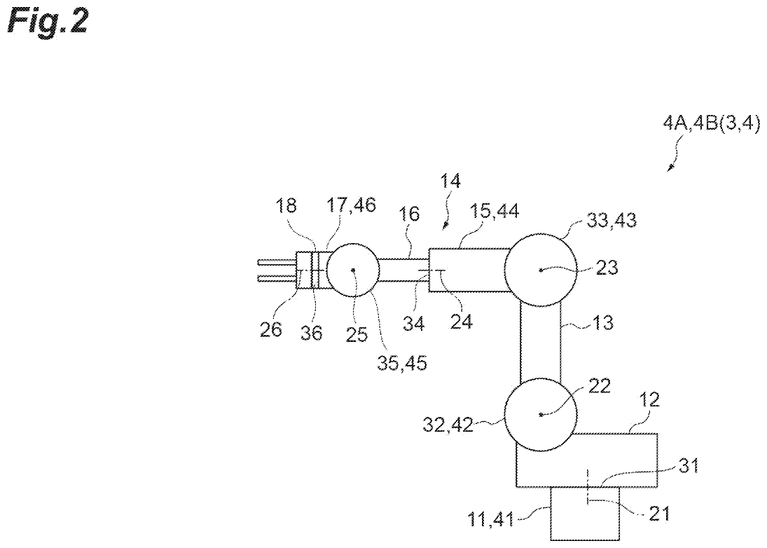

FIG. 2 is a diagram illustrating a schematic configuration of the robots 4A, 4B. The robots 4A, 4B are six-axis vertical articulated robots, for example, and include a base 11, a pivoting part 12, a first arm 13, a second arm 14, a third arm 17, a tip part 18, and actuators 41, 42, 43, 44, 46. The base 11 is placed around the main stage 5A. The pivoting part 12 is mounted on the base 11 to pivot about a vertical axis 21. The first arm 13 is connected to the pivoting part 12 to swing about an axis 22 that intersects (e.g., is orthogonal to) the axis 21. The intersection includes a case where there is a twisted relationship such as so-called three-dimensional intersection. The second arm 14 is connected to the tip part of the first arm 13 so as to swing about an axis 23 substantially parallel to the axis 22. The second arm 14 includes an arm base 15 and an arm end 16. The arm base 15 is connected to the tip part of the first arm 13 and extends along an axis 24 that intersects (e.g., is orthogonal to) the axis 23. The arm end 16 is connected to the tip part of the arm base 15 so as to pivot about the axis 24. The third arm 17 is connected to the tip part of the arm end 16 so as to swing around an axis 25 that intersects (for example, orthogonal to) the axis 24. The tip part 18 is connected to the tip part of the third arm 17 so as to pivot about an axis 26 that intersects (e.g., is orthogonal to) the axis 25.

Thus, the robots 4A, 4B includes a joint 31 that connects the base 11 and the pivoting part 12, a joint 32 that connects the pivoting part 12 and the first arm 13, a joint 33 that connects the first arm 13 and the second arm 14, a joint 34 that connects the arm base 15 and the arm end 16 in the second arm 14, a joint 35 that connects the arm end 16 and the third arm 17, and a joint 36 that connects the third arm 17 and the tip part 18.

The actuators 41, 42, 43, 44, 45, 46 include, for example, an electric motor and a speed reducer and respectively drive joints 31, 32, 33, 34, 35, 36. For example, the actuator 41 pivots the pivoting part 12 about the axis 21, the actuator 42 swings the first arm 13 about the axis 22, the actuator 43 swings the second arm 14 about the axis 23, the actuator 44 pivots the arm end 16 about the axis 24, the actuator 45 swings the third arm 17 about the axis 25, and the actuator 46 pivots the tip part 18 about the axis 26.

The configuration of the robots 4A, 4B can be modified. For example, the robots 4A, 4B may be seven-axis redundant robots in which a one axis joint is added to the six-axis vertical articulated robots, or may be so-called SCARA multiple joint robots.

The main stage 5A supports the robots 4A, 4B, the sub stages 5B, 5C, and the frame 5D. The sub stage 5B supports an object to be worked by the robot 4A. The sub stage 5C supports an object to be worked by the robot 4B. The frame 5D holds various objects (not illustrated) in a space above the main stage 5A. Examples of the object held by the frame 5D include an environment sensor such as a laser sensor or a tool used by the robots 4A, 4B.

The configuration of the machine system 2 illustrated in FIG. 1 is an example. As long as at least one robot is included, the configuration of the machine system 2 can be modified. For example, the machine system 2 may include three or more robots.

The control system 50 controls at least one control target object 4 included in the machine system 2 based on an operation program prepared in advance. The control system 50 may include a plurality of controllers that respectively control a plurality of control target objects 4, and a host controller that outputs control commands to the controllers to coordinate the control target objects 4. FIG. 1 illustrates controllers 51, 52 respectively controlling the robots 4A, 4B and a host controller 53. The host controller 53 outputs a control command to the controllers 51, 52 to coordinate the robots 4A, 4B.

The control system 50 further includes a simulation device 100. The simulation device 100 simulates the condition of the machine system 2. Simulating the condition of the machine system 2 includes simulating a static arrangement relationship of the objects 3. Simulating the condition of the machine system 2 may further include simulating a dynamic arrangement relationship of the objects 3 that changes due to operation of the control target object 4 such as the robots 4A, 4B.

The simulation is useful for evaluating the operation of the robots 4A, 4B based on the operation program before actually operating the robots 4A, 4B. However, if the reliability of the simulation is low, even if the operation is evaluated according to the simulation result, an irregularity such as collision between the objects 3 may occur during actual operation of the robots 4A, 4B.

The motion of the robots 4A, 4B is simulated by kinematic calculation reflecting the motion result of the robots 4A, 4B with respect to a simulation model including arrangement information of the objects 3 including the robots 4A, 4B and structure and dimension information of each of the objects 3.

Improving the accuracy of the simulation model may lead to improving the reliability of the simulation. The simulation device 100 is configured to execute: generating an actual shape model that represents a three-dimensional real shape of the machine system 2 based on measured data; and correcting the simulation model based on a comparison of a simulation model of the machine system 2 and the actual shape model. Thus, the accuracy of the simulation model can be readily improved.

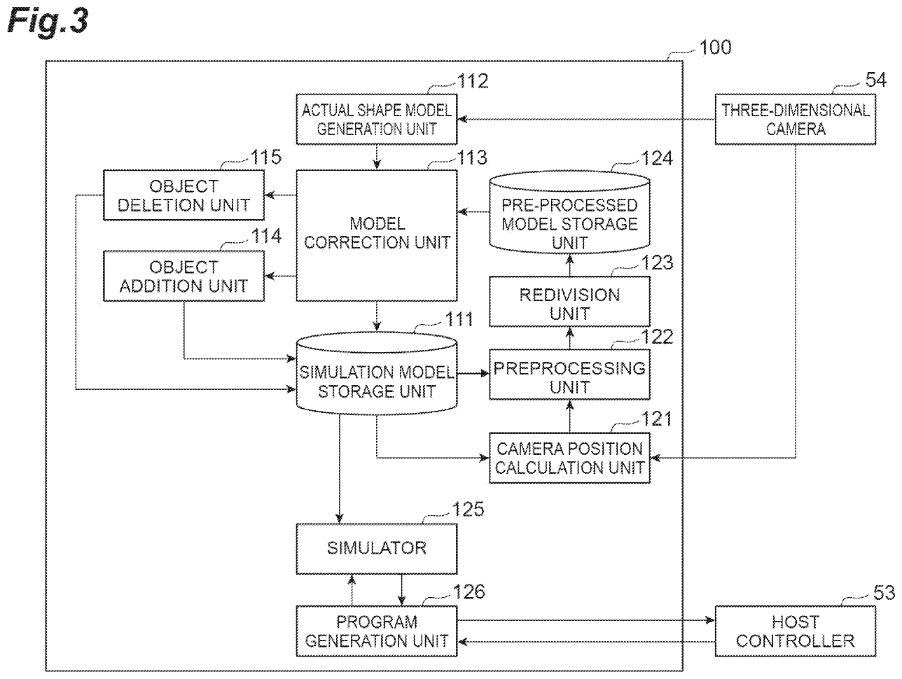

For example, as illustrated in FIG. 3, the simulation device 100 includes a simulation model storage unit 111, an actual shape model generation unit 112, and a model correction unit 113 as functional configurations.

The simulation model storage unit 111 stores a simulation model of the machine system 2. The simulation model includes at least arrangement information of the objects 3 and structure and dimension information of each of the objects 3. The simulation model is prepared in advance based on a design data of the machine system 2 such as a three-dimensional CAD data. The simulation model may include a plurality of object models respectively corresponding to the objects 3. Each of the object models includes arrangement information and structure/dimension information of a corresponding object 3. The arrangement information of the object 3 includes the position and posture of the object 3 in a predetermined simulation coordinate system.

The actual shape model generation unit 112 generates the actual shape model representing the three-dimensional real shape of the machine system 2 based on the measured data. The measured data is a data acquired by actually measuring the machine system 2 in the real space. Examples of the measured data include a three-dimensional real image of the machine system 2 captured by a three-dimensional camera. Examples of the three-dimensional camera include a stereo camera and a time-of-flight (TOF) camera. The three-dimensional camera may be a three-dimensional laser displacement meter.

As an example, the control system 50 includes at least one three-dimensional camera 54 and the actual shape model generation unit 112 generates the actual shape model based on a three-dimensional real image of the machine system 2 captured by the three-dimensional camera 54. The actual shape model generation unit 112 may generate an actual shape model representing a three-dimensional shape of surfaces of the machine system 2 with a point cloud. The actual shape model generation unit 112 may generate an actual shape model representing the three-dimensional shape of the surfaces of the machine system 2 with a set of fine polygons.

The control system 50 may include a plurality of three-dimensional cameras 54. The actual shape model generation unit 112 may obtain multiple three-dimensional real images from the three-dimensional cameras 54 and combine the multiple three-dimensional real images to generate an actual shape model. The actual shape model generation unit 112 may obtain a plurality of three-dimensional real images including an image of a common synthesis object from the three-dimensional cameras 54 and combine the three-dimensional real images to generate an actual shape model so as to match a part corresponding to the synthesis object in each of the three-dimensional real images to a known shape of the synthesis object.

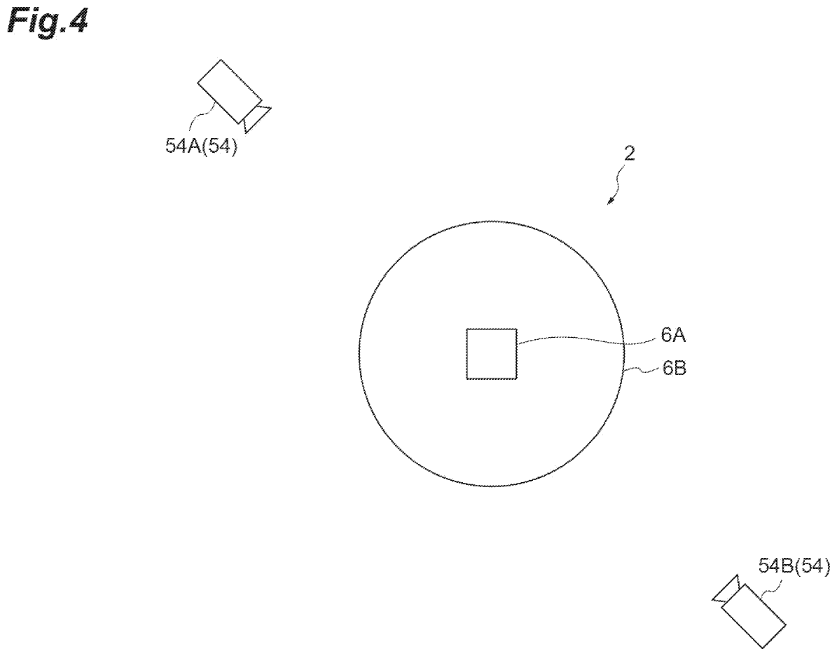

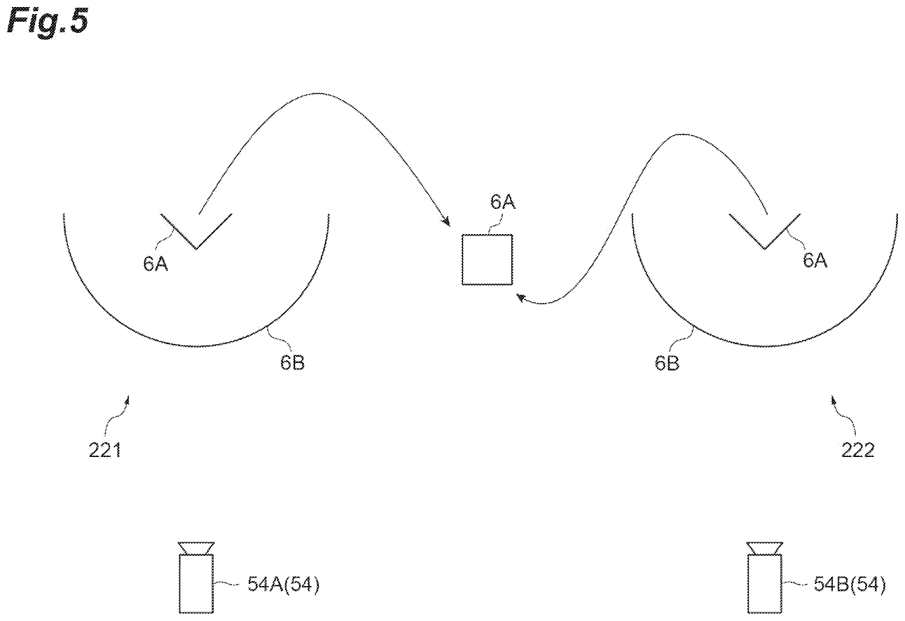

FIG. 4 is a pattern diagram illustrating a target to be captured by two three-dimensional cameras 54. In order to simplify the description, in FIG. 4, the machine system 2 is represented by objects 6A, 6B whose shape are simplified. As illustrated in FIG. 5, a three-dimensional image 221 is acquired by a three-dimensional camera 54A in the upper left of FIG. 4, and a three-dimensional image 222 is acquired by a three-dimensional camera 54B in the lower right of FIG. 4. The three-dimensional image 221 includes a three-dimensional shape of at least a part of the machine system 2 facing the three-dimensional camera 54A. The three-dimensional image 222 includes a three-dimensional shape of at least a part of the machine system 2 facing the three-dimensional camera 54B.

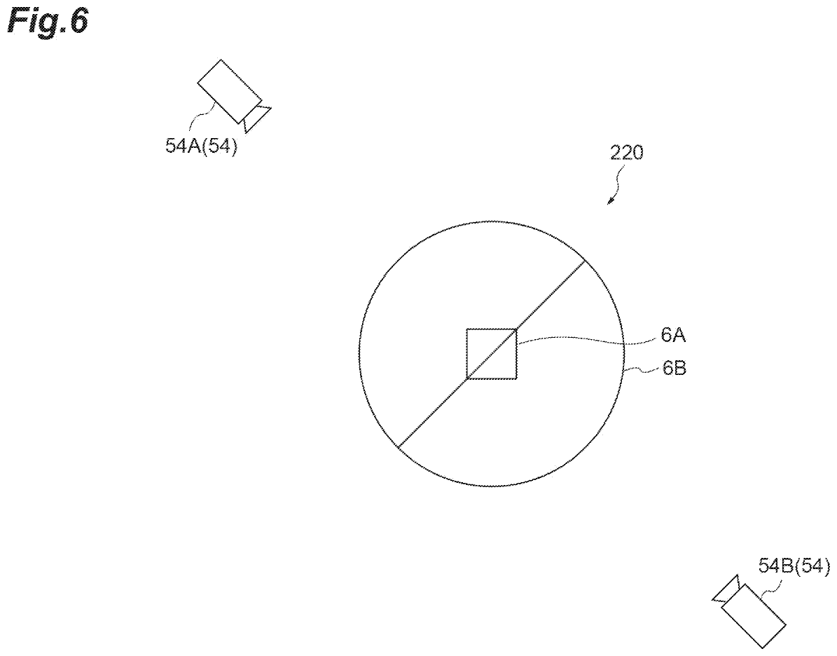

For example, the actual shape model generation unit 112 generates an actual shape model 220 by combining the three-dimensional image 221 and the three-dimensional image 222 with an object 6B as the above-described synthesis object. For example, the actual shape model generation unit 112 matches the three-dimensional shape of the object 6B included in the three-dimensional images 221, 222 to the known three-dimensional shape of the object 6B. Matching here means moving each of the three-dimensional images 221, 222 to fit the three-dimensional shape of the object 6B included in the three-dimensional images 221, 222, to the known three-dimensional shape of the object 6B. By moving each of the three-dimensional images 221, 222 to fit the three-dimensional shape of the object 6B included in the three-dimensional images 221, 222 to the known three-dimensional shape of the object 6B, the three-dimensional images 221, 222 are combined as illustrated in FIG. 6 to produce the actual shape model 220 of the objects 6A, 6B. The actual shape model generation unit 112 may synthesize a three-dimensional image of a plurality of the three-dimensional camera 54 using any one of the robots 4A, 4B, the main stage 5A, the sub stage 5B, the sub stage 5C, and the frame 5D as a synthesis object.

The model correction unit 113 corrects the simulation model based on a comparison of the simulation model stored by the simulation model storage unit 111 and the actual shape model generated by the actual shape model generation unit 112. The model correction unit 113 may correct the simulation model by individually matching the object models to the actual shape model. The matching here means that the position and posture of each of the plurality of object models are corrected so as to fit the actual shape model. The model correction unit 113 may correct the simulation model by repeating matching process including: selecting one matching target model from a plurality of object models; and matching the matching target model to the actual shape model.

The model correction unit 113 may match the matching target model to the actual shape model by excluding a part already matching another object model from the actual shape model in the matching process. The model correction unit 113 may select, as the matching target model, the largest object model among one or more object models that are not selected as the matching target model in the matching process.

By repeating the matching process, the arrangement of the object models is individually corrected. However, there may remain a difference between the simulation model and the actual shape model that cannot be eliminated by the arrangement correction of the plurality of object models. For example, the actual shape model may include a part that does not correspond to any of the object models. In addition, any of the object models may include a part that does not correspond to the actual shape model.

Accordingly, the simulation device 100 may further include an object addition unit 114 and an object deletion unit 115. After the matching process is completed for all of the object models, the object addition unit 114 extracts a part that does not match any object model from the actual shape model, and adds a new object model to the simulation model based on the extracted part. After the matching process is completed for all of the plurality of object models, the object deletion unit 115 extracts a part that does not match the actual shape model from the simulation model, and deletes the extracted part from the simulation model.

Hereinafter, correction of the simulation model by the model correction unit 113, addition of an object model by the object addition unit 114, and deletion of a part of the simulation model by the object deletion unit 115 will be described in detail with reference to the drawings.

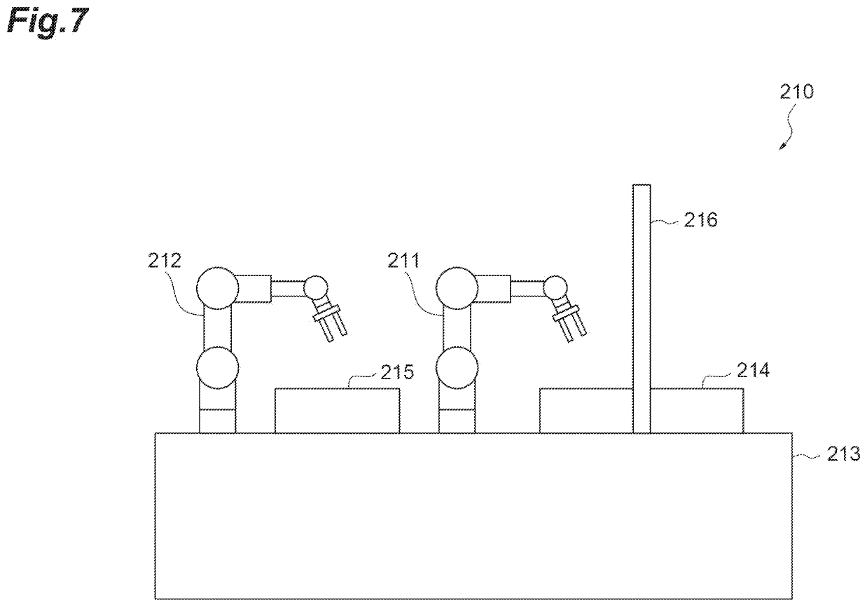

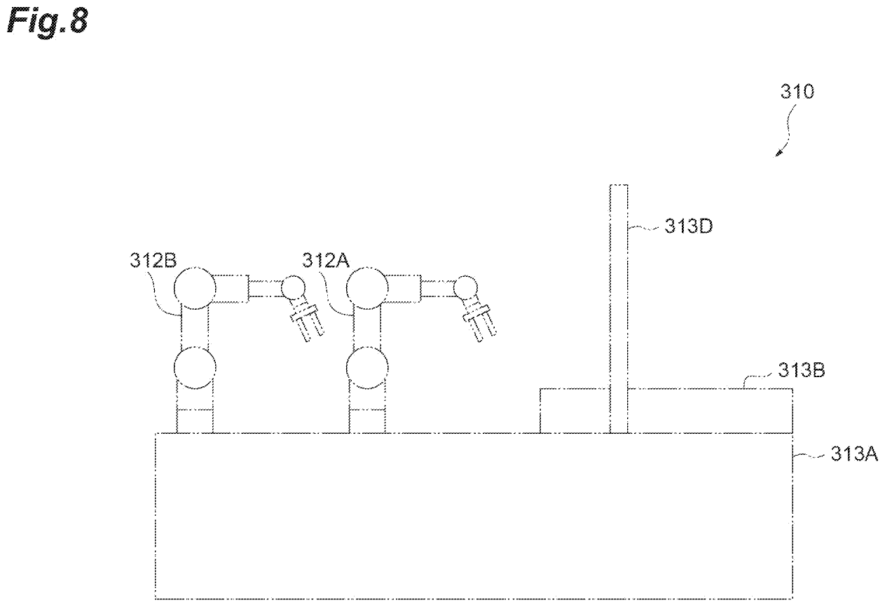

FIG. 7 is a diagram illustrating the actual shape model of the machine system 2, and FIG. 8 is a diagram illustrating the simulation model of the machine system 2. An actual shape model 210 illustrated in FIG. 7 includes a part 211 corresponding to the robot 4A, a part 212 corresponding to the robot 4B, a part 213 corresponding to the main stage 5A, a part 214 corresponding to the sub stage 5B, a part 215 corresponding to the sub stage 5C, and a part 216 corresponding to the frame 5D.

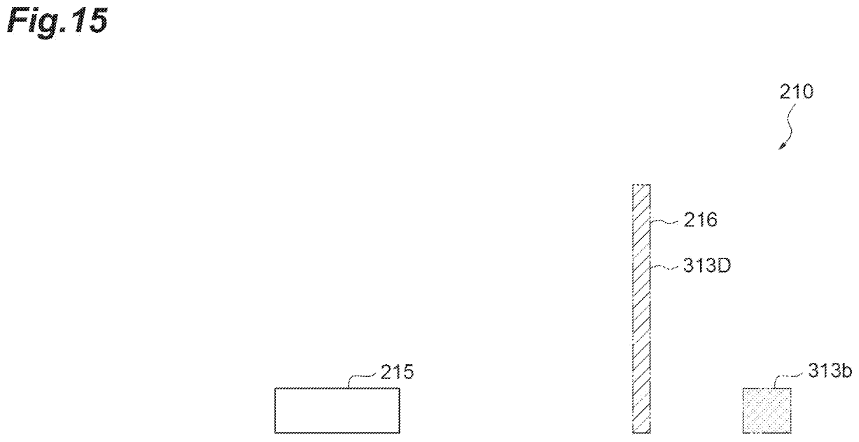

A simulation model 310 illustrated in FIG. 8 includes a robot model 312A corresponding to the robot 4A, a robot model 312B corresponding to the robot 4B, a main stage model 313A corresponding to the main stage 5A, a sub stage model 313B corresponding to the sub stage 5B, and a frame model 313D corresponding to the frame 5D. The simulation model 310 does not include a sub stage model 313C corresponding to the sub stage 5C (see FIG. 15).

The model correction unit 113 first selects the main stage model 313A that is the largest of the robot model 312A, the robot model 312B, the main stage model 313A, the sub stage model 313B, and the frame model 313D. Here, “large” means that the occupied area in the three-dimensional space is large.

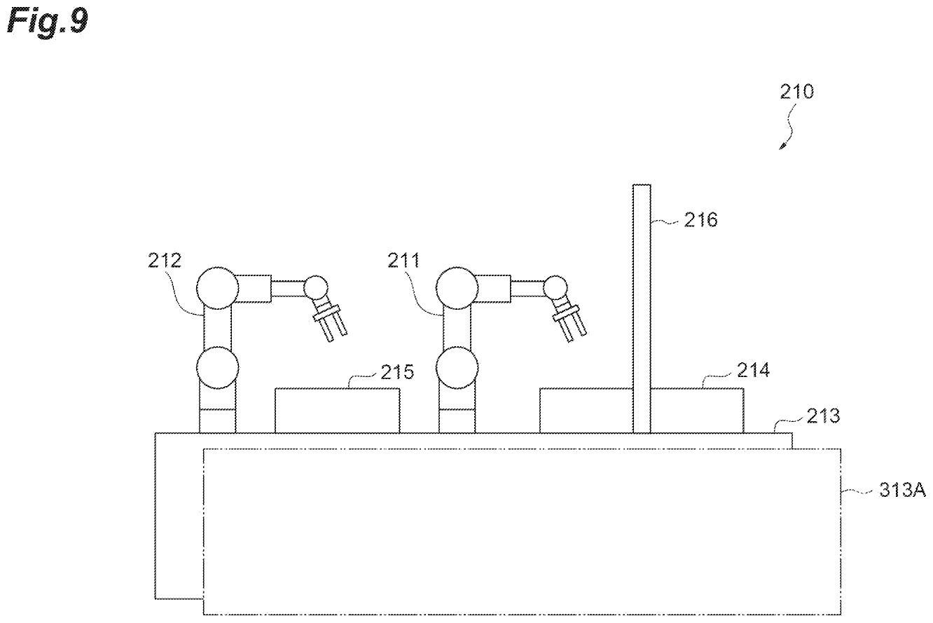

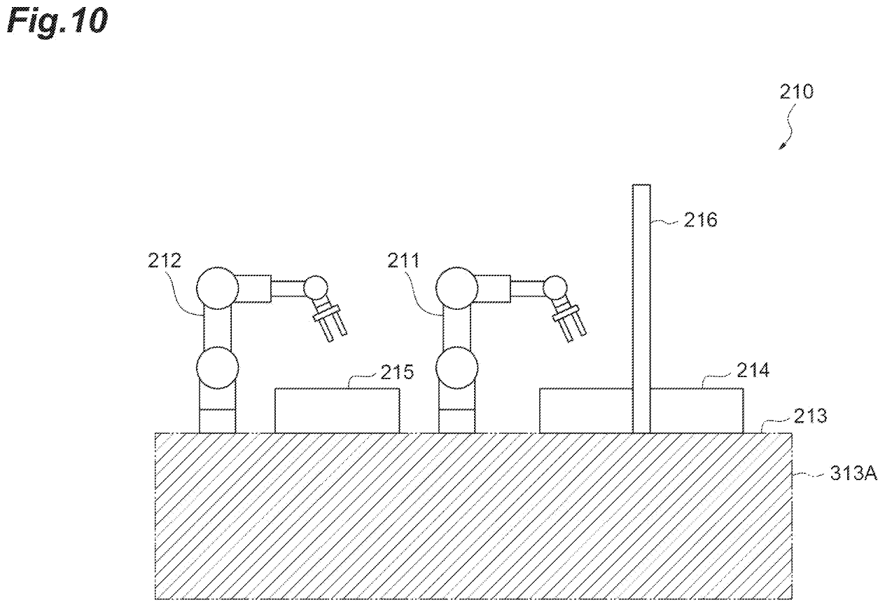

The model correction unit 113 matches the main stage model 313A to the actual shape model 210 as illustrated in FIGS. 9 and 10. As indicated by a hatched part in FIG. 10, the main stage model 313A matches the part 213 corresponding to the main stage 5A of the actual shape model 210.

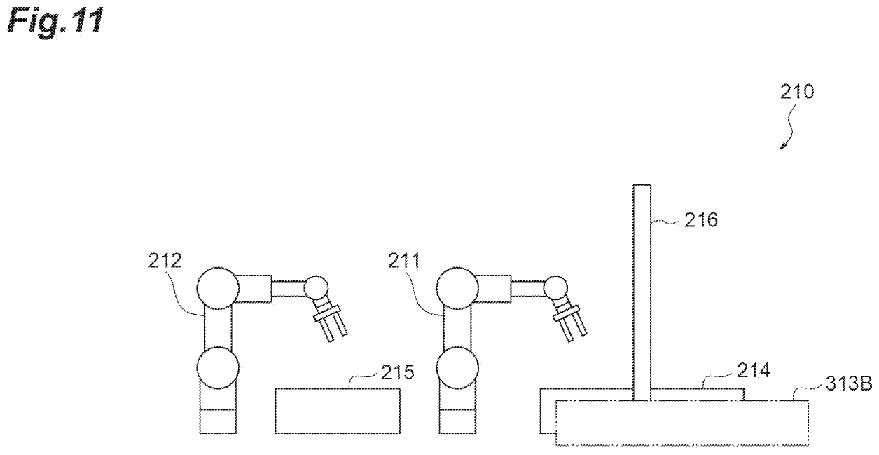

As illustrated in FIG. 11, the model correction unit 113 excludes the part 213 from the actual shape model 210 that already matches the main stage model 313A. Although the part 213 is deleted in FIG. 11, excluding the part 213 from the actual shape model 210 does not mean that the part 213 is deleted from the actual shape model 210. The part 213 may be excluded from matching targets in the next and subsequent matching process while leaving the part 213 in the actual shape model 210 without deleting it, and the same applies to the exclusion of other parts of the actual shape model 210.

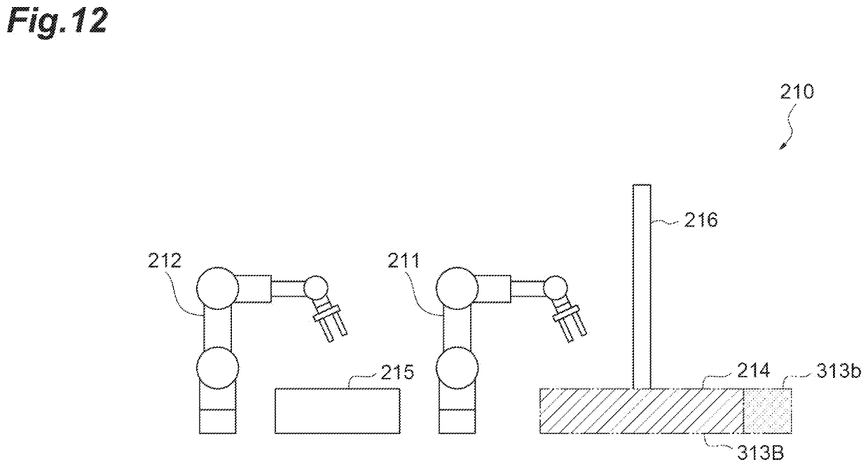

The model correction unit 113 then selects the sub stage model 313B that is the largest of the robot model 312A, the robot model 312B, the sub stage model 313B, and the frame model 313D, and matches the sub stage model 313B to the actual shape model 210 as illustrated in FIG. 12. As indicated by a hatched part in FIG. 12, the sub stage model 313B matches the part 214 corresponding to the sub stage 5B of the actual shape model 210. As indicated by a part with a dot pattern in FIG. 12, the sub stage model 313B includes a part 313b that does not match the part 214.

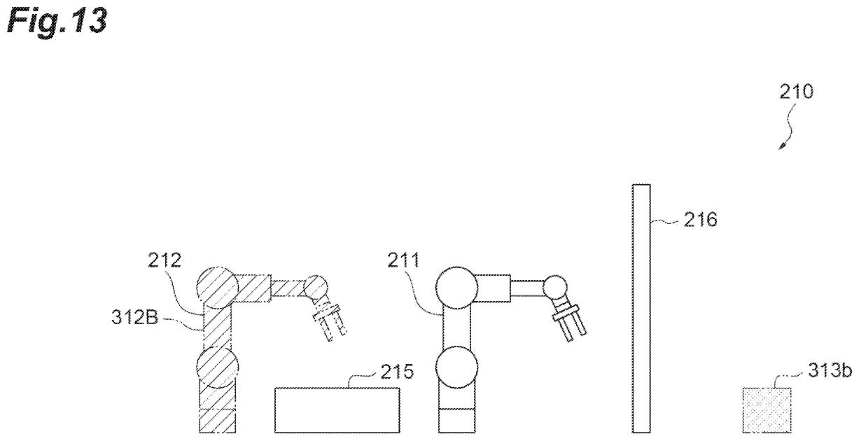

As illustrated in FIG. 13, the model correction unit 113 excludes the part 214 from the actual shape model 210 that already matches the sub stage model 313B. The model correction unit 113 then selects the robot model 312B that is the largest of the robot model 312A, the robot model 312B, and the frame model 313D and matches the robot model 312B to the actual shape model 210. As indicated by a hatched part in FIG. 13, the robot model 312B matches the part 212 corresponding to the robot 4B of the actual shape model 210.

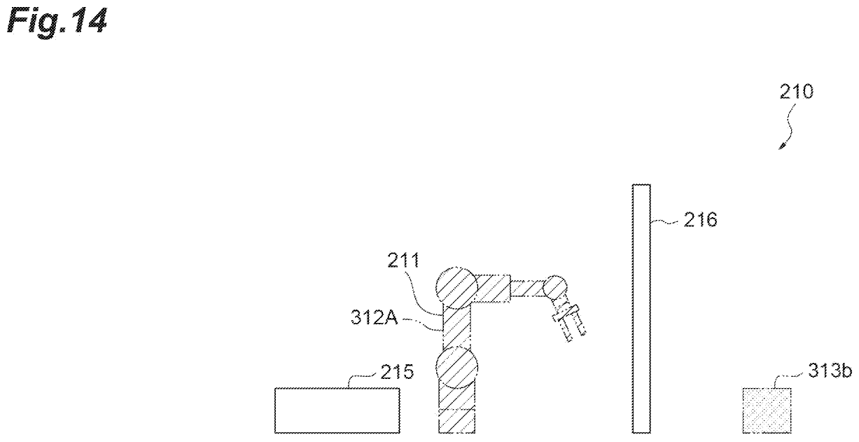

As illustrated in FIG. 14, the model correction unit 113 excludes the part 212 that already matches the robot model 312B from the actual shape model 210. The model correction unit 113 then selects the robot model 312A that is the largest of the robot model 312A and the frame model 313D and matches the robot model 312A to the actual shape model 210. As indicated by a hatched part in FIG. 14, the robot model 312A matches the part 211 corresponding to the robot 4A of the actual shape model 210.

As illustrated in FIG. 15, the model correction unit 113 excludes the part 211 from the actual shape model 210 that already matches the robot model 312A. The model correction unit 113 then selects the frame model 313D and matches the frame model 313D to the actual shape model 210. As indicated by a hatched part in FIG. 15, the frame model 313D matches the part 216 corresponding to the frame 5D of the actual shape model 210.

As described above, the matching process of all of the robots 4A, 4B, the main stage 5A, the sub stage 5B, and the frame 5D is completed, but since the object model corresponding to the sub stage 5C is not included in the simulation model 310, the part 215 of the actual shape model 210 remains without matching any object model included in the simulation model 310.

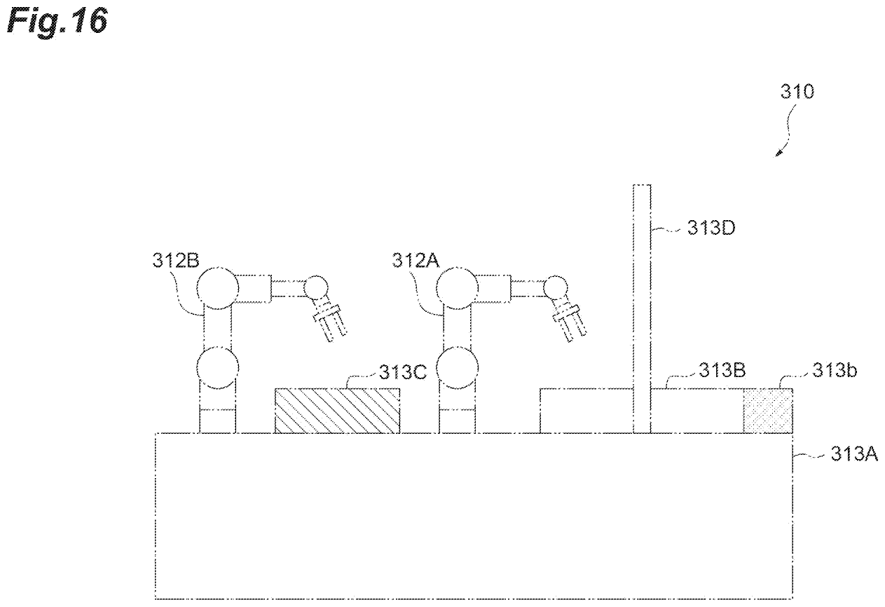

Accordingly, the object addition unit 114 extracts the part 215 and adds the sub stage model 313C corresponding to the sub stage 5C to the simulation model 310 based on the part 215 as illustrated in FIG. 16.

In addition, the part 313b that does not match the actual shape model 210 remains without matching any part of the actual shape model 210. Accordingly, the object addition unit 114 extracts the part 313b and deletes the part 313b from the simulation model 310. Thus, the correction of the simulation model by the model correction unit 113, the addition of the object model by the object addition unit 114, and the deletion of the part by the object deletion unit 115 are completed.

Here, when the actual shape model is generated based on the three-dimensional real image of the machine system 2 captured by the three-dimensional camera 54, the actual shape model may include a hidden part that is not captured by the three-dimensional camera 54. Even when the actual shape model is generated based on a plurality of three-dimensional real images of the machine system 2 captured by a plurality of the three-dimensional cameras 54, the actual shape model may include an overlapping hidden part that is not captured by any of the three-dimensional cameras 54.

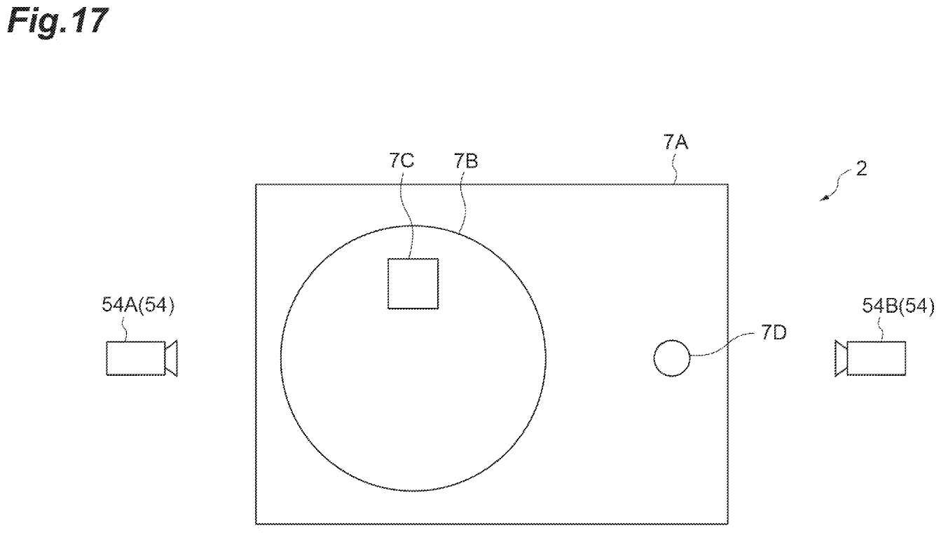

FIG. 17 is a pattern diagram illustrating a target captured by two three-dimensional camera 54. In order to simplify the description, in FIG. 17, the machine system 2 is represented by objects 7A, 7B, 7C, 7D whose shapes are simplified.

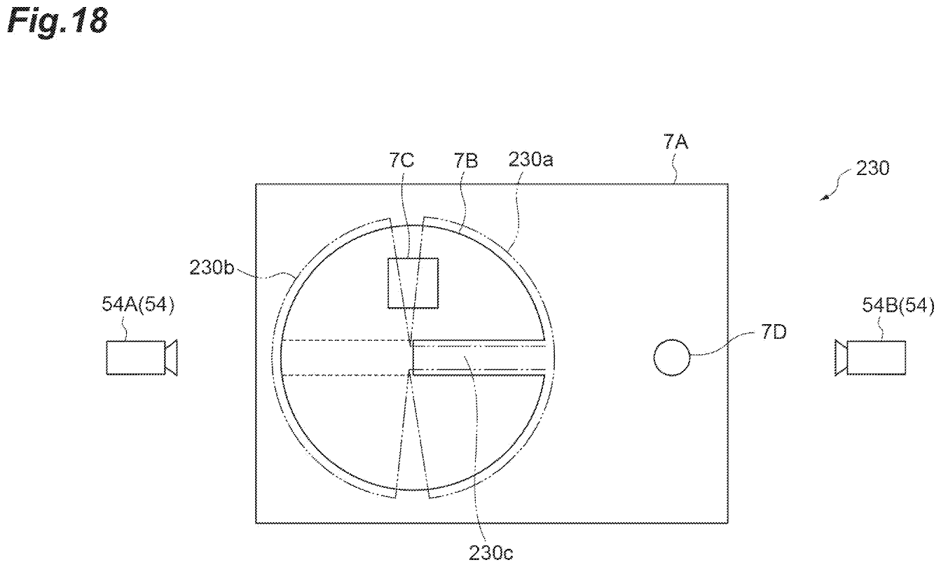

FIG. 18 illustrates an actual shape model 230 generated based on a three-dimensional image captured by the three-dimensional camera 54A on the left of FIG. 17 and a three-dimensional image captured by the three-dimensional camera 54B on the right of FIG. 17.

The actual shape model 230 includes a hidden part 230a that is not captured by the three-dimensional camera 54A, a hidden part 230b that is not captured by the three-dimensional camera 54B, and an overlapping hidden part 230c that is not captured by any of the three-dimensional cameras 54A, 54B. The overlapping hidden part 230c is a part in which the hidden part 230a and the hidden part 230b overlap.

When the simulation model does not include the hidden part although the actual shape model includes the hidden part, the matching accuracy of the object model with respect to the actual shape model may decrease. Accordingly, the simulation device 100 may generate a pre-processed model in which a virtual hidden part corresponding to a hidden part that is not captured by the three-dimensional camera 54 is excluded from the simulation model, and may correct the simulation model based on a comparison between the pre-processed model and the actual shape model.

When the actual shape model is generated based on the three-dimensional real image of the machine system 2 captured by a plurality of three-dimensional cameras 54, the simulation device 100 may generate a pre-processed model in which a virtual overlapping hidden part corresponding to an overlapping hidden part that is not captured by any of the three-dimensional cameras 54 is excluded from the simulation model, and correct the simulation model based on a comparison between the pre-processed model and the actual shape model.

For example, the simulation device 100 may further include a camera position calculation unit 121, a preprocessing unit 122, a redivision unit 123, and a pre-processed model storage unit 124.

The camera position calculation unit 121 calculates the position of the three-dimensional virtual camera so that a three-dimensional virtual image acquired by capturing the simulation model using the three-dimensional virtual camera corresponding to the three-dimensional camera 54 matches the three-dimensional real image. The camera position calculation unit 121 may calculate the position of the three-dimensional virtual camera so as to match a part corresponding to a predetermined calibration object in the three-dimensional virtual image with a part corresponding to the calibration object in the three-dimensional real image.

The camera position calculation unit 121 may set one of the objects 3 as a calibration object, and may set two or more of the objects 3 as calibration objects. For example, the camera position calculation unit 121 may set the robot 4A or the robot 4B as a calibration object.

For example, the camera position calculation unit 121 calculates the position of the three-dimensional virtual camera by repeating: calculating the three-dimensional virtual image under the condition that the three-dimensional virtual camera is disposed at a predetermined initial position, and then evaluating the difference between the calibration object in the three-dimensional virtual image and the calibration object in the three-dimensional real image; and changing the position of the three-dimensional virtual camera until the evaluated result of the difference becomes lower than a predetermined level. The position of the three-dimensional virtual camera also includes the posture of the three-dimensional virtual camera.

The camera position calculation unit 121 may calculate positions of a plurality of three-dimensional virtual cameras respectively corresponding to the three-dimensional cameras 54 so as to match a plurality of three-dimensional virtual images acquired by capturing the simulation model using the three-dimensional virtual cameras with a plurality of three-dimensional real images.

The preprocessing unit 122 calculates a virtual hidden part based on the position of the three-dimensional virtual camera and the simulation model, generates a pre-processed model in which the virtual hidden part is excluded from the simulation model, and stores the pre-processed model in the pre-processed model storage unit 124. For example, the preprocessing unit 122 extracts a visible surface facing the three-dimensional virtual camera from the simulation model, and calculates a part located behind the visible surface as a virtual hidden part.

The preprocessing unit 122 may calculate a virtual overlapping hidden part based on positions of a plurality of three-dimensional virtual cameras and the simulation model, generate a pre-processed model in which the virtual overlapping hidden part is excluded from the simulation model, and store the pre-processed model in the pre-processed model storage unit 124.

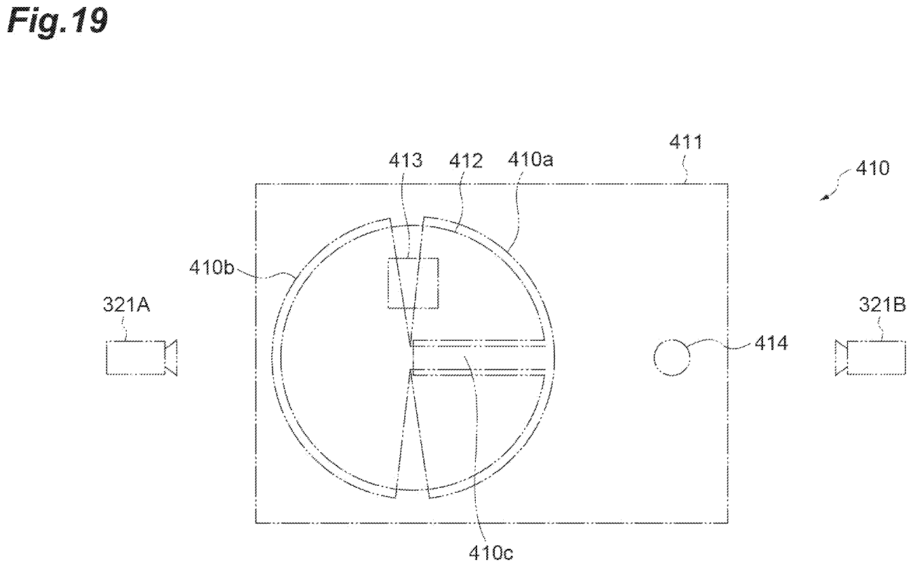

FIG. 19 is a diagram illustrating a pre-processed model 410 generated for the machine system 2 in FIG. 17. The preprocessing unit 122 calculates a virtual hidden part 410a corresponding to the hidden part 230a based on the position of a three-dimensional virtual camera 321A corresponding to the three-dimensional camera 54A in FIG. 17 and the simulation model. Further, the preprocessing unit 122 calculates a virtual hidden part 410b corresponding to the hidden part 230b based on the position of a three-dimensional virtual camera 321B corresponding to the three-dimensional camera 54B in FIG. 17 and the simulation model. In addition, the preprocessing unit 122 calculates a virtual overlapping hidden part 410c that is not captured by any of the three-dimensional virtual cameras 321A, 321B. The virtual overlapping hidden part 410c is a part in which the virtual hidden part 410a and the virtual hidden part 410b overlap.

The preprocessing unit 122 may generate a pre-processed model in data form similar to the data form of the actual shape model. For example, if the actual shape model generation unit 112 generates an actual shape model that represents the three-dimensional shape of the machine system 2 surfaces with a point cloud, the preprocessing unit 122 may generate a pre-processed model that represents the three-dimensional shape of the machine system 2 surfaces with a point cloud. If the actual shape model generation unit 112 generates an actual shape model representing the three-dimensional shape of the machine system 2 surfaces with fine polygons, the preprocessing unit 122 may generate a pre-processed model representing the three-dimensional shape of the machine system 2 surfaces with fine polygons.

By matching the data form between the pre-processed model and the actual shape model, the pre-processed model and the actual shape model may readily be compared. Since the pre-processed model and the actual shape model can be compared with each other even if the data forms of the pre-processed model and the actual shape model are different from each other, the data form of the pre-processed model may not be matched to the data form of the actual shape model.

The redivision unit 123 divides the pre-processed model into a plurality of pre-processed object models respectively corresponding to the objects 3. For example, the redivision unit 123 divides the pre-processed model into a plurality of pre-processed object models based on a comparison between each of the object models stored in the simulation model storage unit 111 and the pre-processed object model.

For example, the redivision unit 123 sets a part corresponding to an object model of an object 7A in the pre-processed model 410 to be a pre-processed object model 411 of the object 7A, sets a part corresponding to an object model of an object 7B in the pre-processed model 410 to be a pre-processed object model 412 of the object 7B, sets part corresponding to an object model of an object 7C in the pre-processed model 410 to be a pre-processed object model 413 of the object 7C, and sets a part corresponding to an object model of an object 7D in the pre-processed model 410 to be a pre-processed object model 414 of the object 7D.

If the simulation device 100 includes the camera position calculation unit 121, the preprocessing unit 122, the redivision unit 123, and the pre-processed model storage unit 124, the model correction unit 113 corrects the simulation model based on a comparison of the pre-processed model stored by the pre-processed model storage unit 124 and the actual shape model generated by the actual shape model generation unit 112. For example, the model correction unit 113 matches each of the object models to the actual shape model based on a comparison of the corresponding pre-processed object model and the actual shape model.

When the actual shape model does not include the hidden part or when the influence of the hidden part on the matching accuracy of the object model with respect to the actual shape model can be ignored, a pre-processed model in which the virtual hidden part is excluded from the simulation model may not be generated. Even in such a case, preprocessing for matching the data form of the simulation model with the data form of the actual shape model may be performed.

The simulation device 100 may further include a simulator 125. The simulator 125 simulates the operation of the machine system 2 based on the simulation model corrected by the model correction unit 113. For example, the simulator 125 simulates the motion of the machine system 2 by a kinematic computation (for example, a forward kinematic computation) that reflects the motion result of the control target object 4 such as the robots 4A, 4B on the simulation model.

The simulation device 100 may further include a program generation unit 126. The program generation unit 126 (planning support apparatus) supports the operation planning of the machine system 2 based on the simulation result by the simulator 125. For example, the program generation unit 126 generates an operation program by repeatedly evaluating the operation program for controlling the control target object 4 such as the robots 4A, 4B based on the simulation result by the simulator 125 and correcting the operation program based on the evaluated result.

The program generation unit 126 may transmit the operation program to the host controller 53 so as to control the control target object 4 based on the generated operation program. Accordingly, the host controller 53 (control device) controls the machine system based on the simulation result by the simulator 125.

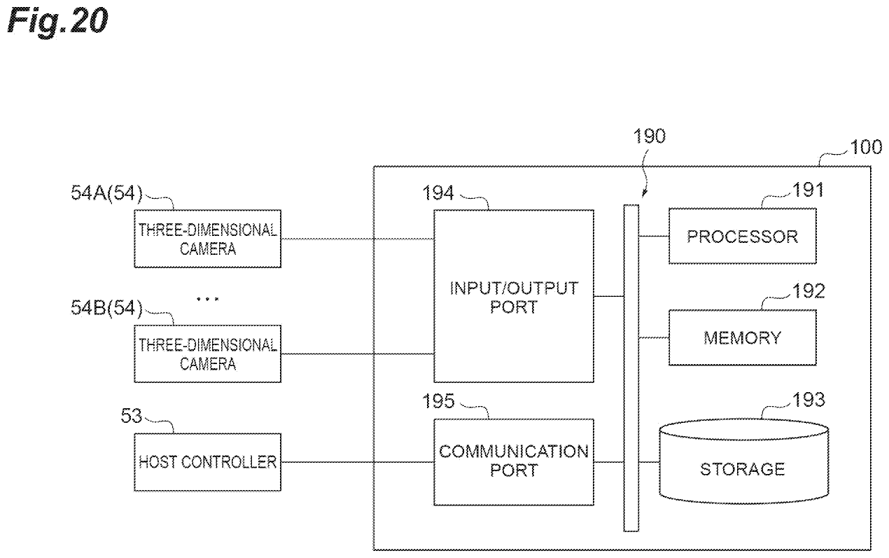

FIG. 20 is a block diagram illustrating the hardware configuration of the simulation device 100. As illustrated in FIG. 20, the simulation device 100 includes circuitry 190. The circuitry 190 includes at least one processor 191, a memory 192, storage 193, an input/output port 194, and a communication port 195. The storage 193 includes a computer-readable storage medium, such as a nonvolatile semiconductor memory. The storage 193 stores at least a program for causing the simulation device 100 to execute: generating an actual shape model representing the three-dimensional real shape of the machine system 2 based on the measured data; and correcting the simulation model of the machine system 2 based on a comparison of the simulation model and the actual shape model. For example, the storage 193 stores a program for causing the simulation device 100 to configure the above-described functional configuration.

The memory 192 temporarily stores the program loaded from the storage medium of the storage 193 and the calculation result by the processor 191. The processor 191 configures each functional block of the simulation device 100 by executing the program in cooperation with the memory 192. The input/output port 194 inputs and outputs information to and from the three-dimensional camera 54 in accordance with instructions from the processor 191. The communication port 195 communicates with the host controller 53 in accordance with instructions from the processor 191.

The circuitry 190 may not be limited to one in which each function is configured by a program. For example, at least a part of the functions of the circuitry 190 may be configured by a dedicated logic circuit or an application specific integrated circuit (ASIC) in which the dedicated logic circuit is integrated.

Modeling Procedure

Next, as an example of the modeling method, a correction procedure of the simulation model executed by the simulation device 100 will be described. This procedure includes: generating an actual shape model representing the three-dimensional real shape of the machine system 2 based on the measured data; and correcting the simulation model of the machine system 2 based on a comparison of the simulation model and the actual shape model.

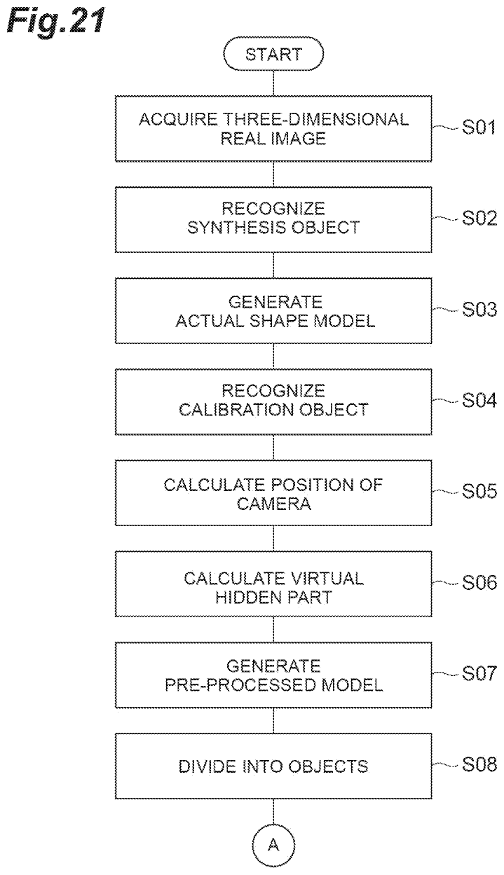

As illustrated in FIG. 21, the simulation device 100 executes operations S01, S02, S03, S04, 505, S06, S07, and S08 in order. In operation S01, the actual shape model generation unit 112 acquires a plurality of three-dimensional real images of the machine system 2 captured by a plurality of the three-dimensional camera 54 respectively. In operation S02, the actual shape model generation unit 112 recognizes a part corresponding to the above-described synthesis object in each of the three-dimensional real images acquired in operation S01. In operation S03, the actual shape model generation unit 112 generates an actual shape model by combining the three-dimensional real images such that a part corresponding to the synthesis object in each of the three-dimensional real images matches the known shape of the synthesis object.

In operation S04, the camera position calculation unit 121 recognizes the part corresponding to the calibration object in each of the three-dimensional real images. In operation 505, the camera position calculation unit 121 calculates the position of the three-dimensional virtual camera so as to match the part corresponding to the calibration object in the three-dimensional virtual image with the part corresponding to the calibration object in the three-dimensional real image for each of the three-dimensional virtual cameras. In operation S06, the preprocessing unit 122 calculates a virtual hidden part of the simulation model that is not captured by the three-dimensional virtual camera based on the position of the three-dimensional virtual camera and the simulation model for each of the three-dimensional virtual cameras.

In operation S07, the preprocessing unit 122 generates a pre-processed model in which the virtual overlapping hidden part that is not captured by any of the plurality of three-dimensional virtual cameras is excluded from the simulation model based on the calculation result of the virtual hidden part in operation S06, and stores the pre-processed model in the pre-processed model storage unit 124. In operation S08, the redivision unit 123 divides the pre-processed model stored in the pre-processed model storage unit 124 into a plurality of pre-processed object models respectively corresponding to a plurality of the object 3.

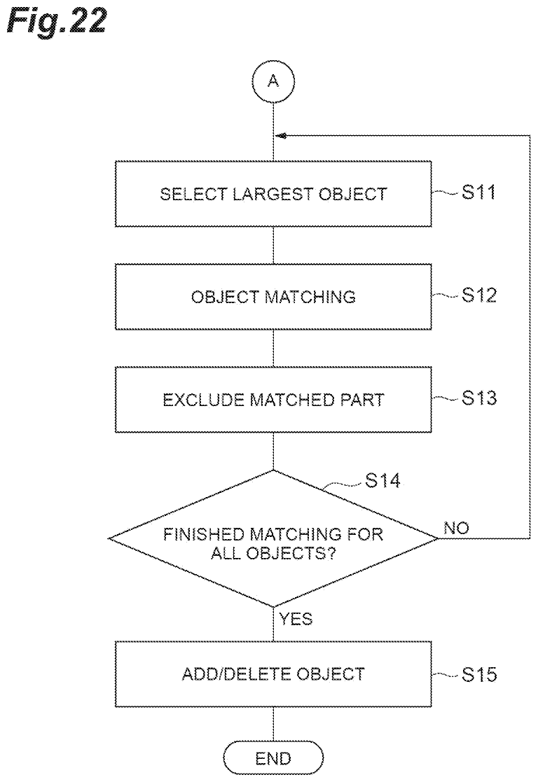

Next, the simulation device 100 executes operations S11, S12, S13, and S14 as illustrated in FIG. 22. In operation S11, the model correction unit 113 selects, as a matching target model, the largest object model among one or more object models that are not selected as matching target models among the plurality of object models. In operation S12, the model correction unit 113 matches the matching target model to the actual shape model based on a comparison of the pre-processed object model corresponding to the matching target model and the actual shape model.

In operation S13, the model correction unit 113 excludes the part matched with the matching target model among the actual shape models from the target of matching process in the next and subsequent times. In operation S14, the model correction unit 113 checks whether matching process for all object models is completed.

If it is determined in operation S14 that an object model for which the matching process is not completed remains, the simulation device 100 returns the processing to operation S11. Thereafter, the selection of the matching target model and the matching of the matching target model with the actual shape model are repeated until the matching of all object models is completed.

If it is determined in operation S14 that matching process for all object models is completed, the simulation device 100 executes operation S15. In operation S15, the object addition unit 114 extracts a part that does not match any object model from the actual shape model, and adds a new object model to the simulation model based on the extracted part. Also, the object deletion unit 115 extracts a part that does not match the actual shape model from the simulation model and deletes the extracted part from the simulation model. This completes the procedure for correcting the simulation model.

As described above, the simulation device 100 includes: the actual shape model generation unit 112 configured to generate, based on measured data, the actual shape model 210 representing a three-dimensional real shape of the machine system 2 including the robots 4A, 4B; and the model correction unit 113 configured to correct the simulation model 310 of the machine system 2 based on a comparison of the simulation model 310 and the actual shape model 210.

With this the simulation device 100, the accuracy of the simulation model 310 can readily be improved. Therefore, the simulation device 100 the reliability of simulation may be improved.

The machine system 2 may include the objects 3 including the robots 4A, 4B. The simulation model 310 may include a plurality of object models respectively corresponding to the objects 3. The model correction unit 113 may be configured to correct the simulation model 310 by individually matching the object models to the actual shape model 210. Matching with respect to the actual shape model 210 is performed for each of the object models, and thus the simulation model 310 may be corrected with improved accuracy.

The model correction unit 113 may be configured to correct the simulation model 310 by repeating matching process including selecting one matching target model from the object models and matching the matching target model to the actual shape model 210. Matching for each of a plurality of objects can readily and reliably be performed.

The model correction unit 113 may be configured to match the matching target model to the actual shape model 210 by excluding a part that already matches another object model from the actual shape model 210 in the matching process. A new matching target model can be matched to the actual shape model 210 without being affected by the part already matched to another object model. Therefore, the simulation model 310 can be corrected with improved accuracy.

The model correction unit 113 may be configured to select, as the matching target model, a largest object model among one or more object models that have not been selected as the matching target model in the matching process. By performing matching in order from the largest object model and excluding the part matched with the object model from the actual shape model 210, the parts to be matched with the matching target model in each matching process may gradually be narrowed down. Therefore, the simulation model 310 can be corrected with improved accuracy.

The simulation device 100 may further include the object addition unit 114 configured to extract, from the actual shape model 210, a part that does not match any object model after the matching process is completed for all of the object models, and add a new object model to the simulation model 310 based on the extracted part. The simulation model 310 can be corrected with improved accuracy.

The simulation device 100 may further include the object deletion unit 115 configured to, after matching process is completed for all of the object models, extract, from the simulation model 310, a part that does not match the actual shape model 210 and delete the extracted part from the simulation model 310. The simulation model 310 can be corrected with improved accuracy.

The actual shape model generation unit 112 may be configured to generate the actual shape model 230 based on a three-dimensional real image of the machine system 2 captured by the three-dimensional camera 54. The simulation device 100 may further include the preprocessing unit 122 configured to generate the pre-processed model 410 in which the virtual hidden part 410a is excluded from the simulation model 310, the virtual hidden part 410a corresponding to the hidden part 230a and 230b, that are not captured by the three-dimensional camera 54. The model correction unit 113 may be configured to correct the simulation model 310 based on a comparison of the pre-processed model 410 and the actual shape model 210. The simulation model 310 may be corrected with improved accuracy by setting, as a comparison target with the actual shape model 230, the pre-processed model 410 acquired by excluding, from the simulation model 310, a part that cannot be represented by the actual shape model 210 because the part is not captured by the three-dimensional camera 54 in the plurality of the object 3.

The actual shape model generation unit 112 may be configured to generate the actual shape model 230 based on a three-dimensional real image of the machine system 2 captured by the three-dimensional camera 54. The simulation device 100 may further include: the preprocessing unit 122 configured to generates the pre-processed model 410 acquired in which the virtual hidden parts 410a, 410b are excluded from the simulation model 310, the virtual hidden parts 410a, 410b corresponding to the hidden parts 230a, 230b that are in the machine system 2 and are not captured by the three-dimensional camera 54; and the redivision unit 123 configured to divide the pre-processed model 410 into a plurality of pre-processed object models respectively corresponding to the objects 3. The model correction unit 113 may be configured to match each of the object models to the actual shape model 210 based on a comparison of the corresponding pre-processed object model and the actual shape model. The simulation model 310 can be corrected with improved accuracy by improving the accuracy of matching for each of the plurality of object models.

The simulation device 100 may further include: the camera position calculation unit 121 configured to calculate the position of the three-dimensional virtual cameras 321A, 321B corresponding to the three-dimensional camera 54 so as to match a three-dimensional virtual image with the three-dimensional image, the three-dimensional virtual image being acquired by capturing the simulation model 310 by the three-dimensional virtual cameras 321A, 321B. The preprocessing unit 122 may be configured to calculate the virtual hidden parts 410a and 410b based on the positions of the three-dimensional virtual cameras 321A, 321B and the simulation model 310. By making the virtual hidden parts 410a and 410b correspond to the hidden part 230a and 230b with improved accuracy, the simulation model 310 can be corrected with improved accuracy.

The camera position calculation unit 121 may be configured to calculate the positions of the three-dimensional virtual cameras 321A, 321B so as to match a part corresponding to a predetermined calibration object in the three-dimensional virtual image to a part corresponding to the calibration object in the three-dimensional real image. The position of the three-dimensional virtual cameras 321A, 321B may readily be corrected by performing matching between the three-dimensional virtual image and the three-dimensional real image on the part corresponding to the calibration object.

The actual shape model generation unit 112 may be configured to acquire a plurality of three-dimensional real images from the three-dimensional cameras 54 including the three-dimensional cameras 54A, 54B, and generate the actual shape model 210 by combining the three-dimensional real images. The preprocessing unit 122 may be configured to generate the pre-processed model 410 in which the virtual overlapping part 410c is excluded from the simulation model 310, the virtual overlapping hidden part 410c corresponding to the overlapping hidden part 230c that is not captured by any of the three-dimensional cameras 54A, 54B. The simulation model 310 can be corrected with improved accuracy by reducing the virtual overlapping hidden part 410c.

The actual shape model generation unit 112 may be configured to acquire a plurality of three-dimensional real images including an image of a common synthesis object from the three-dimensional cameras 54 including the three-dimensional cameras 54A, 54B and may combine the three-dimensional real images to generate the actual shape model 210 so as to match the part corresponding to the synthesis object in each of the three-dimensional real images to the known shape of the synthesis object. A plurality of three-dimensional real images may readily be synthesized to generate the actual shape model 210 having a small hidden part.

The simulation device 100 may further include: the camera position calculation unit 121 configured to calculate positions of the three-dimensional virtual cameras 321A, 321B respectively corresponding to the three-dimensional cameras 54A, 54B so as to match a plurality of three-dimensional virtual images acquired by capturing the simulation model 310 using the three-dimensional virtual cameras 321A, 321B to a plurality of three-dimensional real images. The preprocessing unit 122 may be configured to calculate the virtual overlapping hidden part 410c based on the positions of the plurality of the three-dimensional virtual cameras 321A, 321B and the simulation model 310. The simulation model 310 may be corrected with improved accuracy by making the virtual overlapping hidden part 410c correspond to the overlapping hidden part 230c with improved accuracy.

The actual shape model generation unit 112 may be configured to generate the actual shape model 210 representing the three-dimensional real shape of the machine system 2 as a point cloud. The preprocessing unit 122 may be configured to generate the pre-processed model 410 representing the three-dimensional virtual shape of the simulation model 310 as a virtual point cloud. The difference between the actual shape model 210 and the pre-processed model 410 may readily evaluated.

The actual shape model generation unit 112 may be configured to generate the actual shape model 210 representing the three-dimensional real shape of the machine system 2 as a point cloud. The simulation device 100 may further include a preprocessing unit configured to generate the pre-processed model 410 representing the three-dimensional virtual shape of the simulation model 310 as a virtual point cloud. The model correction unit 113 may be configured to correct the simulation model 310 based on a comparison of the pre-processed model 410 and the actual shape model 210. The difference between the actual shape model 210 and the pre-processed model 410 may readily be evaluated.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A simulation device comprising circuitry configured to:
store a simulation model of a machine system including a robot, the simulation model generated to simulate a three-dimensional real shape of the machine system;
receive measured data acquired by measuring the machine system in a real space;
generate, based on the measured data, an actual shape model representing a three-dimensional real shape of the machine system; and
correct the simulation model of the machine system based on a comparison between the simulation model and the actual shape model.

2. The simulation device according to claim 1, wherein the machine system includes a plurality of objects including the robot,
wherein the simulation model includes a plurality of object models respectively corresponding to the plurality of objects, and
wherein the circuitry is configured to correct the simulation model by individually matching each of the plurality of object models to the actual shape model.

3. The simulation device according to claim 2, wherein the circuitry is configured to correct the simulation model by repeating a matching process that includes:
selecting one matching target model from the plurality of object models; and
matching the matching target model to the actual shape model.

4. The simulation device according to claim 3, wherein the matching process further includes excluding, from the actual shape model, a part that has matched the matching target model, and
wherein circuitry is configured to match, in the matching process, the matching target model to the actual shape model from which one or more parts that has matched one or more other object models are excluded.

5. The simulation device according to claim 4, wherein circuitry is configured to select, as the matching target model, a largest object model among all object models of the plurality of object models that have not yet been selected as the matching target model in the matching process.

6. The simulation device according to claim 3, wherein the circuitry is further configured to:
extract, from the actual shape model, one or more parts each of which does not match any object model after the matching process is completed for all of the plurality of object models; and
add one or more new object models to the simulation model based on the extracted one or more parts of the actual shape model.

7. The simulation device according to claim 3, wherein the circuitry is further configured to:
extract, from the simulation model, one or more virtual parts each of which does not match the actual shape model after the matching process is completed for all of the plurality of object models; and
delete the extracted one or more virtual parts from the simulation model.

8. The simulation device according to claim 1, wherein the circuitry is further configured to:
generate the actual shape model based on the measured data that includes a three-dimensional real image of the machine system acquired by measuring the machine system by a three-dimensional camera in the real space;
generate a pre-processed model by excluding, from the simulation model, one or more virtual hidden parts that has not been measured by the three-dimensional camera; and
correct the simulation model based on a comparison between the pre-processed model and the actual shape model.

9. The simulation device according to claim 2, wherein the circuitry is further configured to:
generate the actual shape model based on the measured data that includes a three-dimensional real image of the machine system acquired by measuring the machine system by a three-dimensional camera;
generate a pre-processed model by excluding, from the simulation model, one or more virtual hidden parts included in one or more areas that has not been measured by the three-dimensional camera;
divide the pre-processed model into a plurality of pre-processed object models respectively corresponding to the plurality of objects; and
individually match each of the plurality of object models to the actual shape model based on a comparison of a corresponding pre-processed object model and the actual shape model.

10. The simulation device according to claim 8, wherein the circuitry further configured to:
calculate a position of a three-dimensional virtual camera corresponding to the three-dimensional camera to match a three-dimensional virtual image with the three-dimensional real image, the three-dimensional virtual image being acquired by virtually measuring the simulation model by the three-dimensional virtual camera in a virtual space; and
calculate the one or more virtual hidden parts based on the position of the three-dimensional virtual camera and the simulation model.

11. The simulation device according to claim 10, wherein the circuitry is configured to calculate the position of the three-dimensional virtual camera to match one or more virtual calibration parts corresponding to one or more predetermined calibration objects in the three-dimensional virtual image to one or more parts corresponding to the one or more predetermined calibration objects in the three-dimensional real image.

12. The simulation device according to claim 8, wherein the circuitry is configured to:
acquire the measured data that includes a plurality of three-dimensional real images from a plurality of three-dimensional cameras including the three-dimensional camera;
generate the actual shape model by combining the plurality of three-dimensional real images; and
generate the pre-processed model by excluding, from the simulation model, one or more virtual overlapping hidden parts that has not been measured by any of the plurality of three-dimensional cameras.

13. The simulation device according to claim 12, wherein the circuitry is configured to:
acquire the plurality of three-dimensional real images each of which includes an image of a common synthesis object from the plurality of three-dimensional cameras; and
combine the plurality of three-dimensional real images to generate the actual shape model to match a part corresponding to the synthesis object in each of the plurality of three-dimensional real images to a predetermined shape of the synthesis object.

14. The simulation device according to claim 12, wherein the circuitry is further configured to:
calculate positions of a plurality of three-dimensional virtual cameras respectively corresponding to the plurality of three-dimensional cameras to match a plurality of three-dimensional virtual images acquired by capturing the simulation model using the plurality of three-dimensional virtual cameras to the plurality of three-dimensional real images; and
calculate the virtual overlapping hidden part based on the positions of the plurality of three-dimensional virtual cameras and the simulation model.

15. The simulation device according to claim 8, wherein the circuitry is configured to:
generate the actual shape model representing the three-dimensional real shape of the machine system by point cloud data; and
generate the pre-processed model representing a three-dimensional virtual shape of the simulation model by virtual point cloud data.

16. The simulation device according to claim 1, wherein the circuitry is further configured to:
generate the actual shape model representing a three-dimensional real shape of the machine system by point cloud data;
generate a pre-processed model representing a three-dimensional virtual shape of the simulation model by virtual point cloud data; and
correct the simulation model based on a comparison between the pre-processed model and the actual shape model.

17. The simulation device according to claim 1, wherein the circuitry is further configured to simulate an operation of the machine system based on the corrected simulation model.

18. A control system comprising:
the simulation device according to claim 17; and
a control circuitry configured to control the machine system based on a simulation of the operation of the machine system based on the corrected simulation model.

19. A modeling method including:
storing a simulation model of a machine system including a robot, the simulation model generated to simulate a three-dimensional real shape of the machine system;
receiving measured data acquired by measuring the machine system in a real space;
generating, based on the measured data, an actual shape model representing a three-dimensional real shape of the machine system; and
correcting the simulation model of the machine system based on a comparison between the simulation model and the actual shape model.

20. A non-transitory memory device having instructions stored thereon that, in response to execution by a processing device, cause the processing device to perform operations comprising:
storing a simulation model of a machine system including a robot, the simulation model generated to simulate a three-dimensional real shape of the machine system;
receiving measured data acquired by measuring the machine system in a real space;
generating, based on the measured data, an actual shape model representing a three-dimensional real shape of the machine system; and
correcting the simulation model of the machine system based on a comparison between the simulation model and the actual shape model.
